(19) United States
(12) Patent Application Publication
(10) Pub. No.: US 2025/0338226 A1
(43) Pub. Date: Oct. 30, 2025

(54) ELECTRONIC DEVICE AND METHOD FOR CONTROLLING RADIO UNIT TO SAVE POWER

(71) Applicant: Samsung Electronics Co., Ltd., Suwon-si (KR)

(72) Inventors: Sub HUR, Suwon-si (KR); Eunhyun KWON, Suwon-si (KR); Gihyun KIM, Suwon-si (KR); Sunwook KIM, Suwon-si (KR)

(21) Appl. No.: 19/259,633

(22) Filed: Jul. 3, 2025

Related U.S. Application Data
(63) Continuation of application No. PCT/KR2023/020031, filed on Dec. 6, 2023.

(30) Foreign Application Priority Data
Jan. 6, 2023 (KR) 10-2023-0002385
Feb. 14, 2023 (KR) 10-2023-0019632

(51) Int. Cl. H04W 52/02; H04W 76/20

(52) U.S. Cl. CPC H04W 52/0274; H04W 52/0235; H04W 76/20

(57) ABSTRACT

An electronic device of a radio unit (RU) is provided. The electronic device includes memory, including one or more storage media, storing instructions, at least one transceiver, and at least one processor communicatively coupled to the at least one transceiver and the memory, wherein the instructions, when executed by the at least one processor individually or collectively, cause the RU to receive, from a distributed unit (DU), through at least one transceiver of the electronic device, a configuration request message to configure a low-power mode that deactivates at least one component of the RU, the configuration request message including cycle information indicating a transmission cycle of a test request message, and counter information indicating the maximum number of transmissions of the test request message, after receiving the configuration request message control the at least one component of the RU to be deactivated, transmit, to the DU, the test request message for identifying a transition to a normal mode based on the cycle information, and activate the at least one component of the RU based on the number of transmissions of the test request message exceeding the maximum number of transmissions or an inspection response message indicating the normal mode is received.

### CROSS-REFERENCE TO RELATED APPLICATION(S)

This application is a continuation application, claiming priority under 35 U.S.C. § 365(c), of an International application No. PCT/KR2023/020031, filed on Dec. 6, 2023, which is based on and claims the benefit of a Korean patent application number 10-2023-0002385, filed on Jan. 6, 2023, in the Korean Intellectual Property Office, and of a Korean patent application number 10-2023-0019632, filed on Feb. 14, 2023, in the Korean Intellectual Property Office, the disclosure of each of which is incorporated by reference herein in its entirety.

### BACKGROUND

### 1. Field

The disclosure relates to an electronic device and a method for controlling a radio unit (RU) for power saving.

### 2. Description of Related Art

In wireless communication systems, as transmission capacity increases, a function split that functionally separates base stations is being applied. According to the function split, the base station may be separated into a distributed unit (DU) and a radio unit (RU). In a case that traffic usage is low, a mobile communication system may reduce power consumption by deactivating some radio units (RUs).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for controlling a radio unit (RU) for power saving.

Additional aspects will be set forth in part in the description which follows and, in part, will be apparent from the description, or may be learned by practice of the presented embodiments.

In accordance with an aspect of the disclosure, an electronic device of a radio unit (RU) is provided. The electronic device includes memory, including one or more storage media, storing instructions, at least one transceiver, and at least one processor communicatively coupled to the at least one transceiver and the memory, wherein the instructions, when executed by the at least one processor individually or collectively, cause the RU to receive, via the at least one transceiver from a distributed unit (DU), a configuration request message for setting a low-power mode for deactivating at least one component of the RU, the configuration request message including period information indicating a transmission period of an inspection request message and counter information indicating a maximum number of transmissions of the inspection request message, after receiving the configuration request message, control the at least one component of the RU to be deactivated, transmit the inspection request message for identifying a transition to a normal mode to the DU based on the period information, activate the at least one component of the RU based on the number of transmissions of the inspection request message being exceeding the maximum number of transmissions or an inspection response message indicating the normal mode being received.

In accordance with another aspect of the disclosure, an electronic device of a distributed unit (DU) is provided. The electronic device includes memory, including one or more storage media, storing instructions, at least one transceiver, and at least one processor communicatively coupled to the at least one transceiver and the memory, wherein the instructions, when executed by the at least one processor individually or collectively, cause the DU to transmit, to a radio unit (RU), a configuration request message for setting a low-power mode for deactivating at least one component of the RU, wherein the configuration request message includes period information indicating a transmission period of an inspection request message and counter information indicating a maximum number of transmissions of the inspection request message, receive the inspection request message for identifying a transition to a normal mode from the RU, and transmit an inspection response message indicating the low-power mode or the normal mode to the RU in response to the inspection request message.

In accordance with another aspect of the disclosure, a method performed by a radio unit (RU) is provided. The method includes receiving, via at least one transceiver from a distributed unit (DU), a configuration request message for setting a low-power mode for deactivating at least one component of the RU, wherein the configuration request message includes period information indicating a transmission period of an inspection request message and counter information indicating a maximum number of transmissions of the inspection request message, controlling the at least one component of the RU to be deactivated, after receiving the configuration request message, transmitting the inspection request message for identifying a transition to a normal mode to the DU based on the period information, and activating the at least one component of the RU based on the number of transmissions of the inspection request message being exceeding the maximum number of transmissions or an inspection response message indicating the normal mode being received.

According to embodiments of the disclosure, one or more non-transitory computer-readable storage media storing one or more computer programs including computer-executable instructions that, when executed by a processor of a distributed unit (DU)), cause the DU to perform operations are provided. The operations include transmitting, to a radio unit (RU), a configuration request message for setting a low-power mode for deactivating at least one component of the RU. wherein the configuration request message includes period information indicating a transmission period of an inspection request message and counter information indicating a maximum number of transmissions of the inspection request message, receiving the inspection request message for identifying a transition to a normal mode from the RU, transmitting, in response to the inspection request message, an inspection response message indicating the low-power mode or the normal mode to the RU.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 illustrates a fronthaul interface according to an embodiment of the disclosure;

FIG. 3A illustrates a functional configuration of a distributed unit (DU) according to embodiments.

FIG. 3B illustrates a functional configuration of a radio unit (RU) according to an embodiment of the disclosure;

FIG. 4 illustrates a function split between a DU and an RU according to an embodiment of the disclosure;

FIG. 5 illustrates a setting for deactivating some components of a radio unit (RU) according to an embodiment of the disclosure;

FIG. 6 illustrates a functional configuration of a radio unit (RU) to be activated in a low-power mode, according to an embodiment of the disclosure;

FIG. 7A illustrates signaling between a distributed unit (DU) and a radio unit (RU) for a transition to a normal mode based on counter information, according to an embodiment of the disclosure;

FIG. 7B illustrates signaling between a distributed unit (DU) and a radio unit (RU) for a transition to a normal mode based on an inspection response message, according to an embodiment of the disclosure;

FIG. 8 illustrates a flow of operations of a distributed unit (DU) for reducing power consumption of a base station according to an embodiment of the disclosure; and

FIG. 9 illustrates a flow of operations of a radio unit (RU) for reducing power consumption of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

Terms referring to signal (e.g., signal, information, message, signaling), terms referring to operation, administration, maintenance processor (OAM processor) (e.g., OAM processor, operation, administration and maintenance processor (OA&M), operation, administration, maintenance and processor (OAM&P), operation and maintenance processor (O&M), operation, maintenance processor (OM), operation, administration, maintenance processor (OAMP), operation, administration, maintenance, troubleshooting processor (OAMPT), DU control processor), terms referring to resource (e.g., symbol, slot, subframe, radio frame, subcarrier, resource element (RE), resource block (RB), bandwidth part (BWP), occasion), terms for operational states (e.g., step, operation, procedure), terms referring to data (e.g., packet, user stream, information, bit, symbol, codeword), terms referring to channel, terms referring to network entity, terms referring to low-power mode (e.g., low-power mode, power saving mode, sleep mode, idle mode, adaptive mode, optimization mode), terms referring to normal modes (e.g., normal mode, connected mode, awake mode), and terms referring to components of a device, which are used in the following description are exemplified for convenience of explanation. Therefore, the disclosure is not limited to terms to be described below, and another term having an equivalent technical meaning may be used.

Terms referring to parts of an electronic device (e.g., substrate, printed circuit board (PCB), flexible PCB (FPCB), module, antenna, antenna element, circuit, processor, chip, component, device), terms referring to a shape of parts (e.g., structure, structural object, supporting portion, contacting portion, protrusion), terms referring to connecting portion between structures (e.g., connecting portion, contacting portion, supporting portion, contact structure, conductive member, assembly), and terms referring to circuit (e.g., PCB, FPCB, signal line, feeding line, data line, radio frequency (RF) signal line, antenna line, RF path, RF module, RF circuit, splitter, divider, coupler, combiner), which are used in the following description are exemplified for convenience of explanation. Therefore, the disclosure is not limited to terms to be described below, and another term having an equivalent technical meaning may be used. In addition, a term, such as ‘ . . . unit’, ‘ . . . device’, ‘ . . . object’, and ‘ . . . structure’, and the like used below may mean at least one shape structure or may mean a unit processing a function.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

Although the disclosure describes various embodiments using terms used in some communication standards (e.g., 3^{rd} generation partnership project (3GPP), extensible radio access network (xRAN), open-radio access network (O-RAN)), these are only examples for explanation. The various embodiments of the disclosure may be easily modified and applied to other communication systems.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Hereinafter, various embodiments disclosed in this document are described with reference to the attached drawings. For convenience of explanation, components illustrated in the drawings may be exaggerated or reduced in size, and the disclosure is not necessarily limited to what is illustrated.

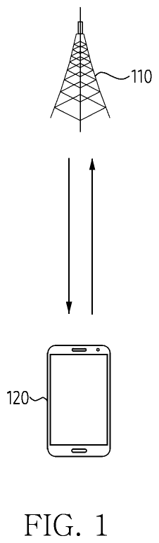

FIG. 1 illustrates a wireless communication system according to an embodiment of the disclosure.

Referring to FIG. 1, it illustrates a base station 110 and a terminal 120 as a portion of nodes that utilize a wireless channel in a wireless communication system. FIG. 1 illustrates only one base station, but a wireless communication system may further include another base station that is identical or similar to the base station 110.

According to an embodiment of the disclosure, the base station 110 is a network infrastructure that provides wireless access to the terminal 120. The base station 110 has coverage defined based on a distance at which a signal may be transmitted. In addition to ‘base station’, the base station 110 may be referred to as an ‘access point (AP)’, ‘eNodeB (eNB)’, ‘₅′ generation node’, ‘next generation nodeB (gNB)’, ‘wireless point’, ‘transmission/reception point (TRP)’ or other terms having equivalent technical meanings.

According to an embodiment of the disclosure, the terminal 120, which is a device used by a user, performs communication with the base station 110 through a wireless channel. A link from the base station 110 to the terminal 120 is referred to as a downlink (DL), and a link from the terminal 120 to the base station 110 is referred to as an uplink (UL). In addition, although not illustrated in FIG. 1, the terminal 120 and another terminal may perform communication with each other through a wireless channel. At this time, a link (device-to-device link (D2D)) between the terminal 120 and the other terminal is referred to as a sidelink, and the sidelink may be used interchangeably with a PC5 interface. In some other embodiments of the disclosure, the terminal 120 may be operated without the user's involvement. According to an embodiment of the disclosure, the terminal 120, which is a device performing machine type communication (MTC), may not be carried by the user. Additionally, according to an embodiment of the disclosure, the terminal 120 may be a narrowband (NB)-Internet of things (IoT) device.

According to an embodiment of the disclosure, in addition to ‘terminal’, the terminal 120 may also be referred to as ‘user equipment (UE)’, ‘customer premises equipment, (CPE)’, ‘mobile station’, ‘subscriber station’, ‘remote terminal’, ‘wireless terminal’, ‘electronic device’, ‘user device’, or other terms having equivalent technical meanings.

According to an embodiment of the disclosure, the base station 110 may perform beamforming with the terminal 120. The base station 110 and the terminal 120 may transmit and receive a wireless signal in a relatively low frequency band (e.g., frequency range 1 (FR 1) of NR). In addition, the base station 110 and the terminal 120 may transmit and receive a wireless signal in a relatively high frequency band (e.g., FR 2 (or FR 2-1, FR 2-2, FR 2-3) or FR 3), and a millimeter wave (mmWave) band (e.g., 28 GHz, 30 GHz, 38 GHz, 60 GHz). The base station 110 and the terminal 120 may perform beamforming to improve a channel gain. Herein, the beamforming may include transmission beamforming and reception beamforming. The base station 110 and the terminal 120 may provide directivity to a transmission signal or a reception signal. To this end, the base station 110 and the terminal 120 may select serving beams through a beam search or beam management procedure. After the serving beams are selected, subsequent communication may be performed through a resource in a quasi-co-located (QCL) relationship with the resource transmitting the serving beams.

According to an embodiment of the disclosure, if large-scale characteristics of a channel carrying a symbol on a first antenna port may be inferred from a channel carrying a symbol on a second antenna port, the first antenna port and the second antenna port may be evaluated to be in the QCL relationship. For example, large-scale characteristics may include at least one of a delay spread, a Doppler spread, a Doppler shift, an average gain, an average delay, and a spatial receiver parameter.

Although FIG. 1 describes that both the base station 110 and the terminal 120 perform beamforming, the embodiments of the disclosure are not necessarily limited thereto. In some embodiments of the disclosure, the terminal may or may not perform beamforming. In addition, the base station may or may not perform beamforming. For example, either only one of the base station and the terminal may perform beamforming, or neither the base station nor the terminal may perform beamforming.

In the disclosure, a beam refers to a spatial flow of a signal in a wireless channel, and is formed by one or more antennas (or antenna elements), and this formation process may be referred to as beamforming. Beamforming may include at least one of analog beamforming or digital beamforming (e.g., precoding). A reference signal transmitted based on beamforming may include, for example, a demodulation-reference signal (DM-RS), a channel state information-reference signal (CSI-RS), a synchronization signal/physical broadcast channel (SS/PBCH), and a sounding reference signal (SRS). In addition, an IE, such as CSI-RS resource or SRS-resource may be used as a configuration for each reference signal, and this configuration may include information associated with the beam. The information associated with the beam may mean whether a corresponding configuration (e.g., CSI-RS resource) uses the same spatial domain filter as another configuration (e.g., another CSI-RS resource within the same CSI-RS resource set) or a different spatial domain filter, or which reference signal it is quasi-co-located (QCL) with, and if so, what type it is (e.g., QCL type A, B, C, D).

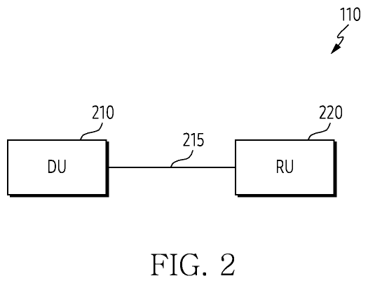

In the related art, in a communication system with a relatively large cell radius of base station, each base station was installed to include a function of a digital processing unit (or distributed unit (DU)) and a radio frequency (RF) processing unit (or radio unit (RU)). However, as high frequency bands are used in 4^{th} generation (4G) and/or subsequent communication systems (e.g., 5^{th} generation (5G)) and the cell coverage of base stations becomes smaller, the number of base stations to cover a specific area has increased. The burden of installation cost for operators to install base stations has also increased. In order to minimize the installation cost of a base station, a structure in which the DU and RU of the base station are separated, one or more RUs are connected to one DU through a wired network, and one or more Rus geographically distributed to cover a specific area are deployed, has been proposed. Hereinafter, a deployment structure and expansion examples of a base station according to various embodiments of the disclosure are described through FIG. 2.

FIG. 2 illustrates a fronthaul interface according to an embodiment of the disclosure. Unlike a backhaul between a base station and a core network, the fronthaul refers to a section between entities between a radio network and a base station. FIG. 2 illustrates an example of a fronthaul structure between one DU 210 and one RU 220, but this is only for convenience of explanation and the disclosure is not limited thereto. In other words, the embodiments of the disclosure may also be applied to a fronthaul structure between one DU and a plurality of RU. For example, the embodiments of the disclosure may be applied to a fronthaul structure between one DU and two RU. In addition, the embodiments of the disclosure may also be applied to a fronthaul structure between one DU and three RU.

Referring to FIG. 2, the base station 110 may include a DU 210 and an RU 220. A fronthaul 215 between the DU 210 and the RU 220 may be operated via an Fx interface. For operation of the fronthaul 215, an interface, such as a common public radio interface (CPRI), an enhanced common public radio interface (eCPRI) or radio over ethernet (ROE) may be used.

As communication technology has been developed, mobile data traffic increased, and thus the bandwidth demand required in a fronthaul between a digital unit and a radio unit has increased significantly. In a deployment, such as centralized/cloud radio access network (C-RAN), the DU 210 may be implemented to perform functions for packet data convergence protocol (PDCP), radio link control (RLC), media access control (MAC), and physical (PHY), and the RU 220 may be implemented to further perform functions for PHY layer in addition to a radio frequency (RF) function.

According to an embodiment of the disclosure, the DU 210 may be in charge of upper layer functions of a wireless network. For example, the DU 210 may perform functions of the MAC layer and a part of the PHY layer. Herein, a part of the PHY layer is a function performed at a higher level among the functions of the PHY layer, and may include, for example, channel encoding (or channel decoding), scrambling (or descrambling), modulation (or demodulation), and layer mapping (or layer demapping). According to an embodiment of the disclosure, if the DU 210 complies with an O-RAN standard, it may be referred to as an O-RAN DU (0-DU). The DU 210 may be replaced with and represented as a first network entity for a base station (e.g., gNB) in embodiments of the disclosure, as needed.

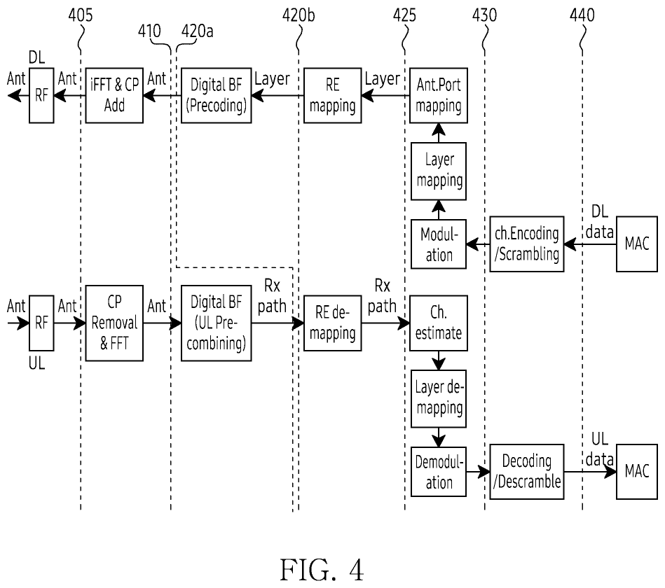

According to an embodiment of the disclosure, the RU 220 may be in charge of lower layer functions of a wireless network. For example, the RU 220 may perform a part of the PHY layer, and a RF function. Herein, a part of the PHY layer is a function performed at performed at a relatively lower level than the DU 210 among the functions of the PHY layer, and may include, for example, inverse fast Fourier transform (iFFT) conversion (or fast Fourier transform (FFT) conversion), CP insertion (CP removal), and digital beamforming. In FIG. 4, an example of such a specific function split is described below. The RU 220 may be referred to as access unit (AU), access point (AP), transmission/reception point (TRP), remote radio head (RRH), radio unit (RU), or other terms having equivalent technical meanings. According to an embodiment of the disclosure, if the RU 220 complies with the O-RAN standard, it may be referred to as an O-RAN RU (O-RU). The RU 220 may be replaced with and represented as a second network entity for a base station (e.g., gNB) in embodiments of the disclosure, as needed.

Although FIG. 2 describes that the base station 110 includes the DU 210 and the RU 220, the embodiments of the disclosure are not limited thereto. The base station according to the embodiments may be implemented in a distributed deployment according to a centralized unit (CU) configured to perform functions of upper layers (e.g., packet data convergence protocol (PDCP), radio resource control (RRC)) of an access network and a distributed unit (DU) configured to perform functions of lower layers. Between a core (e.g., 5G core (5GC) or next generation core (NGC)) network and a radio access network (RAN), the base station may be implemented in a structure in which CU, DU, and RU are arranged in order. In order to explain the relationship between DU and RU, the expression “digital unit (DU)” is sometimes used, however, in the disclosure, a description of digital unit (DU) may also be understood as a description of distributed unit (DU). An interface between the CU and the distributed unit (DU) may be referred to as an F1 interface.

The centralized unit (CU) may be in charge of functions of a higher layer than the DU, by being connected to one or more DUs. For example, the CU may be in charge of radio resource control (RRC) and a function of a packet data convergence protocol (PDCP) layer, and the DU and the RU may be in charge of functions of lower layers. The DU may perform radio link control (RLC), media access control (MAC), and some functions (high PHY) of PHY layer, and the RU may perform remaining functions (low PHY) of the PHY layer. In addition, as an example, a digital unit (DU) may be included in a distributed unit (DU) according to the implementation of distributed deployment of the base station. Hereinafter, unless otherwise defined, it is described as operations of the distributed unit (DU) and the RU, but various embodiments of the disclosure may be applied to both of a base station arrangement including the CU or an arrangement where the DU is directly connected to a core network (i.e., the CU and the DU are integrated into a base station (e.g., NG-RAN node) which is a single entity).

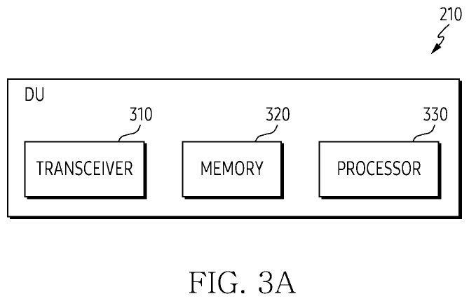

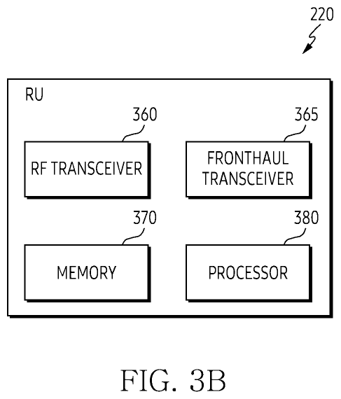

FIG. 3A illustrates a functional configuration of a distributed unit (DU) according to an embodiment of the disclosure. A configuration exemplified in FIG. 3A, which is as a part of a base station, may be understood as a configuration of the DU 210 of FIG. 2. Hereinafter, the terms ‘ . . . unit’ and ‘ . . . er’ used below refer to a unit processing at least one function or operation, which may be implemented by hardware or software, or a combination of hardware and software.

Referring to FIG. 3A, a DU 210 includes a transceiver 310, memory 320, and a processor 330.

According to an embodiment of the disclosure, the transceiver 310 may perform functions for transmitting and receiving a signal in a wired communication environment. The transceiver 310 may include a wired interface for controlling a direct device-to-device connection through a transmission medium (e.g., copper wire, optical fiber). For example, the transceiver 310 may transmit an electrical signal to another device through a copper wire or perform conversion between an electrical signal and an optical signal. The DU 210 may communicate with a radio unit (RU) through the transceiver 310. The DU 210 may be connected to a core network or a CU of a distributed deployment through the transceiver 310.

According to an embodiment of the disclosure, the transceiver 310 may also perform functions for transmitting and receiving a signal in a wireless communication environment. For example, the transceiver 310 may perform a conversion function between a baseband signal and a bit string according to a physical layer specification of a system. For example, upon transmitting data, the transceiver 310 generates complex-valued symbols by encoding and modulating a transmission bit string. In addition, upon receiving data, the transceiver 310 restores a received bit string by demodulating and decoding a baseband signal. In addition, the transceiver 310 may include a plurality of transmission/reception paths. In addition, according to an embodiment of the disclosure, the transceiver 310 may be connected to a core network or to other nodes (e.g., integrated access backhaul (IAB)).

According to an embodiment of the disclosure, the transceiver 310 may transmit and receive a signal. The transceiver 310 may transmit a signal to another network entity (e.g., the RU 220) or receive a signal. For example, the transceiver 310 may transmit a management plane (M-plane) message. For example, the transceiver 310 may transmit a synchronization plane (S-plane) message. For example, the transceiver 310 may transmit or receive a control plane (C-plane) message. For example, the transceiver 310 may transmit or receive a user plane (U-plane) message. Although only the transceiver 310 is illustrated in FIG. 3A, the DU 210 may include two or more transceivers according to another implementation.

According to an embodiment of the disclosure, the transceiver 310 transmits and receives a signal as described above. Accordingly, all or some of the transceiver 310 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the transceiver 310.

Although not illustrated in FIG. 3A, the transceiver 310 may further include a backhaul transceiver for connection with a core network or another base station. The backhaul transceiver provides an interface for performing communication with other nodes in the network. In other words, the backhaul transceiver converts a bit string transmitted from a base station to another node, such as another access node, another base station, an upper node, and a core network into a physical signal, and converts a physical signal received from another node into a bit string.

According to an embodiment of the disclosure, the memory 320 stores a basic program, an application program, and data, such as configuration information for an operation of the DU 210. The memory 320 may be referred to as a storage unit. The memory 320 may be configured with volatile memory, nonvolatile memory, or a combination of the volatile memory and the nonvolatile memory. In addition, the memory 320 provides stored data according to a request from the processor 330.

According to an embodiment of the disclosure, the processor 330 controls overall operations of the DU 210. The processor 380 may be referred to as a control unit. For example, the processor 330 transmits and receives a signal through the transceiver 310 (or through a backhaul communication unit). In addition, the processor 330 writes and reads data in the memory 320. In addition, the processor 330 may perform functions of a protocol stack required in a communication standard. Although only the processor 330 is illustrated in FIG. 3A, the DU 210 may include two or more processors according to another implementation.

A configuration of the DU 210 illustrated in FIG. 3A is only an example, and an example of the DU performing the embodiments of the disclosure is not limited to the configuration illustrated in FIG. 3A. In some embodiment of the disclosure, some configurations may be added, deleted, or changed.

FIG. 3B illustrates a functional configuration of a radio unit (RU) according to an embodiment of the disclosure. A configuration exemplified in FIG. 3B, which is as a part of a base station, may be understood as a configuration of the RU 220 of FIG. 2. Hereinafter, the terms ‘ . . . unit’ and ‘ . . . er’ used below refer to a unit processing at least one function or operation, which may be implemented by hardware or software, or a combination of hardware and software.

Referring to FIG. 3B, the RU 220 includes an RF transceiver 360, a fronthaul transceiver 365, memory 370, and a processor 380.

According to an embodiment of the disclosure, the RF transceiver 360 performs functions for transmitting and receiving a signal through a wireless channel. For example, the RF transceiver 360 up-converts a baseband signal into an RF band signal and then transmits it through an antenna, and down-converts an RF band signal received through the antenna into a baseband signal. For example, the RF transceiver 360 may include a transmission filter, a reception filter, a power amplifier, a mixer, an oscillator, a digital-to-analog converter (DAC), and an analog-to-digital converter (ADC).

According to an embodiment of the disclosure, the RF transceiver 360 may include a plurality of transmission/reception paths. Furthermore, the RF transceiver 360 may include an antenna unit. The RF transceiver 360 may include at least one antenna array including a plurality of antenna elements. In terms of hardware, the RF transceiver 360 may be including a digital circuit and an analog circuit (e.g., a radio frequency integrated circuit (RFIC)). Herein, the digital circuit and the analog circuit may be implemented as a single package. In addition, the RF transceiver 360 may include a plurality of RF chains. The RF transceiver 360 may perform beamforming. In order to provide directivity to a signal to be transmitted and received according to the setting of the processor 380, the RF transceiver 360 may apply beamforming weights to the signal. According to an embodiment of the disclosure, the RF transceiver 360 may include a radio frequency (RF) block (or RF unit).

According to an embodiment of the disclosure, the RF transceiver 360 may transmit and receive a signal on a radio access network. For example, the RF transceiver 360 may transmit a downlink signal. The downlink signal may include a synchronization signal (SS), a reference signal (RS) (e.g., cell-specific reference signal (CRS), demodulation (DM)-RS), system information (e.g., MIB, SIB, remaining system information (RMSI), other system information (OSI)), configuration message, control information or downlink data. In addition, for example, the RF transceiver 360 may receive an uplink signal. The uplink signal may include a random access-related signal (e.g., random access preamble (RAP)) (or message 1 (Msg1), message 3 (Msg3)), a reference signal (e.g., sounding reference signal (SRS), DM-RS), or a power headroom report (PHR). Although only the RF transceiver 360 is illustrated in FIG. 3B, the RU 220 may include two or more RF transceivers according to another implementation.

According to an embodiment of the disclosure, the fronthaul transceiver 365 may transmit and receive a signal. The fronthaul transceiver 365 may transmit or receive a signal to or from another network entity (e.g., the DU 210). The fronthaul transceiver 365 may transmit and receive a signal on a fronthaul interface. For example, the fronthaul transceiver 365 may receive a management plane (M-plane) message. For example, the fronthaul transceiver 365 may receive a synchronization plane (S-plane) message. For example, the fronthaul transceiver 365 may transit or receive a control plane (C-plane) message. For example, the fronthaul transceiver 365 may transmit or receive a user plane (U-plane) message. Although only the fronthaul transceiver 365 is illustrated in FIG. 3B, the RU 220 may include two or more fronthaul transceivers according to another implementation.

According to an embodiment of the disclosure, as described above, the RF transceiver 360 and the fronthaul transceiver 365 transmit and receive a signal. Accordingly, all or some of the RF transceiver 360 and the fronthaul transceiver 365 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the RF transceiver 360. In the following description, transmission and reception performed through a wireless channel are used to the meaning including that the processing as described above is performed by the RF transceiver 360.

According to an embodiment of the disclosure, the memory 370 stores a basic program, an application program, and data, such as configuration information for an operation of the RU 220. The memory 370 may be referred to as a storage unit. The memory 370 may be configured with volatile memory, nonvolatile memory, or a combination of the volatile memory and the nonvolatile memory. In addition, the memory 370 provides stored data according to a request from the processor 380. According to an embodiment of the disclosure, the memory 370 may include memory for a condition, a command, or a setting value related to an SRS transmission scheme.

According to an embodiment of the disclosure, the processor 380 controls overall operations of the RU 220. The processor 380 may be referred to as a control unit. For example, the processor 380 transmits and receives a signal through the RF transceiver 360 or the fronthaul transceiver 365. In addition, the processor 380 writes and reads data in the memory 370. In addition, the processor 380 may perform functions of a protocol stack required by a communication standard. Although only the processor 380 is illustrated in FIG. 3B, the RU 220 may include two or more processors according to another implementation. The processor 380, which is an instruction set or code stored in the memory 370, may be an instruction/code at least temporarily resided in the processor 380 or a storage space storing instruction/code, or part of circuitry constituting the processor 380. In addition, the processor 380 may include various modules for performing communication. The processor 380 may control the RU 220 to perform operations according to embodiments to be described later.

A configuration of the RU 220 illustrated in FIG. 3B is only an example, and an example of the RU performing the embodiments of the disclosure is not limited to the configuration illustrated in FIG. 3B. In some embodiment of the disclosure, some configurations may be added, deleted, or changed.

FIG. 4 illustrates a function split between a DU and an RU according to an embodiment of the disclosure. As wireless communication technology advances (e.g., the introduction of 5^{th} generation (5G) communication system (or new radio (NR) communication system)), the used frequency bands have increased further. As a cell radius of base stations became very small, the number of RUs required to be installed further increased. In addition, in the 5G communication system, as the amount of data transmitted has increased significantly by more than 10 times, a transmission capacity of a wired network transmitted to a fronthaul has increased significantly. Due to the above-described factors, the installation cost of a wired network in the 5G communication system may be increased significantly. Therefore, in order to reduce the transmission capacity of the wired network and reduce the installation cost of the wired network, a ‘function split’ to reduce a transmission capacity of the fronthaul by transferring some functions of the DU's modem to the RU may be used.

In order to reduce the burden on the DU, a role of the RU, which was in charge of only the existing RF function, may be extended to include some functions of a physical layer. As the RU performs functions of the higher layer, the throughput of the RU increases, which may increase a transmission bandwidth in the fronthaul while lowering the delay time requirement constraints due to response processing. On the other hand, as the RU performs the functions of the higher layer, a virtualization gain decreases and the size, weight, and cost of the RU increase. Based on the trade-off of the above-described advantages and disadvantages, it is required to implement an optimal function split.

Referring to FIG. 4, function splits in a physical layer below a MAC layer are illustrated. In a case of downlink (DL) transmitting signals to a terminal through a wireless network, a base station may sequentially perform channel encoding/scrambling, modulation, layer mapping, antenna mapping, RE mapping, digital beamforming (e.g., precoding), iFFT conversion/CP insertion, and RF conversion. In a case of uplink (UL) receiving signals from a terminal through the wireless network, the base station may sequentially perform RF conversion, FFT conversion/CP removal, digital beamforming (pre-combining), RE demapping, channel estimation, layer demapping, demodulation, decoding/discrambling. According to the above-described trade-off, the split of uplink functions and downlink functions may be defined in various types, by needs among vendors, discussion of standards, and the like.

According to an embodiment of the disclosure, in a first function split 405, a first function split in which the RU performs the RF function, and the DU performs the PHY function is substantially such that the PHY function is not implemented within the RU, and, for example, may be referred to as Option 8. In a second function split 410, the RU performs iFFT conversion/CP insertion in the DL of the PHY function and FFT conversion/CP removal in the UL, and the DU performs the remaining PHY functions. As an example, the second function split 410 may be referred to as Option 7-1. In a third function split 420a, the RU performs iFFT conversion/CP insertion in the DL of the PHY function and FFT conversion/CP removal and digital beamforming in the UL, and the DU performs the remaining PHY functions. As an example, the third function split 420a may be referred to as Option 7-2x Category A. In a fourth function split 420b, the RU performs digital beamforming in both DL and UL, and the DU performs upper PHY functions after digital beamforming. As an example, the fourth function split 420b may be referred to as Option 7-2x Category B. In a fifth function split 425, the RU performs RE mapping (or RE demapping) in both DL and UL, and the DU performs upper PHY functions after RE mapping (or RE demapping). As an example, the fifth function split 425 may be referred to as Option 7-2. In a sixth function split 430, the RU performs up to modulation (or demodulation) in both DL and UL, and the DU performs upper PHY functions after modulation (or demodulation). As an example, the sixth function split 430 may be referred to as Option 7-3. In a seventh function split 440, the RU performs up to encoding/scrambling (or decoding/discrambling) in both DL and UL, and the DU performs upper PHY functions after modulation (or demodulation). As an example, the seventh function split 440 may be referred to as option 6.

According to an embodiment of the disclosure, in a case that a large amount of signal processing is expected, such as in FR 1 MMU, a function split (e.g., the fourth function split 420b) in a relatively high layer may be required to reduce a fronthaul capacity. Additionally, in a function split (e.g., the sixth function split 430) at a too high layer, as a control interface becomes complex and multiple PHY processing blocks are included in the RU, which may cause a burden on the implementation of the RU, a suitable function split may be required according to the arrangement and implementation method of the DU and RU.

According to an embodiment of the disclosure, in a case that precoding of data received from the DU cannot be processed (i.e., in a case that there is a limit to the precoding capability of the RU), the third function split 420a or a lower function split (e.g., the second function split 410) may be applied. Conversely, in a case that there is a capability to process precoding of data received from the DU, the fourth function split 420b or a higher function split (e.g., the sixth function split 430) may be applied.

According to an embodiment of the disclosure hereinafter, the upper-PHY refers to physical layer processing processed in the DU of the fronthaul interface. For example, the upper-PHY may include FEC encoding/decoding, scrambling, modulation/demodulation. Hereinafter, the lower-PHY refers to physical layer processing processed in the RU of the fronthaul interface. For example, the lower-PHY may include FFT/iFFT, digital beamforming, physical random access channel (PRACH) extraction and filtering. However, the above-described criteria do not exclude embodiments through other function splits. The operations of the DU 210, the operations of the RU 220, and the signaling between the DU 210 and the RU 220 described below are not limitedly interpreted by a specific function split.

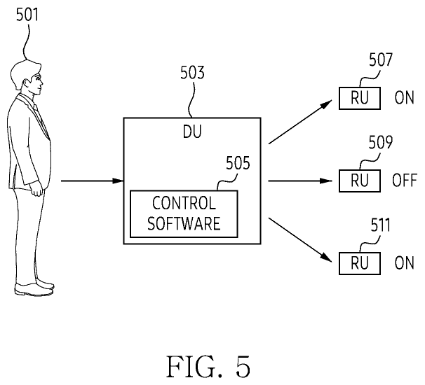

FIG. 5 illustrates a setting for deactivating some components of a radio unit (RU) according to an embodiment of the disclosure.

Referring to FIG. 5, a system operator 501 may input a signal for setting a low power mode into a control software 505 that controls a distributed unit (DU) 503. The DU 503 may perform some functions (high PHY) of a radio link control (RLC), a media access control (MAC), and a physical (PHY) layer. The DU 503 may refer to the DU 210 of FIG. 2. The control software 505 may control the DU 503. For example, the control software may be a processor for operation, administration, and maintenance (OAM). However, it is not limited thereto. The RU 507, the RU 509, and the RU 511 may transmit and receive messages from the DU 503. The RU 507 may adjust whether to activate at least one component included in the RU 507, based on the message received from the DU 503. The RU 509 may adjust whether to activate at least one component included in the RU 509, based on the message received from the DU 503. The RU 511 may adjust whether to activate at least one component included in the RU 511, based on a message received from the DU 503. The RU (e.g., the RU 507, the RU 509, and/or the RU 511) may be in charge of remaining functions (low PHY) that are not performed by the DU 503 in the PHY layer.

According to an embodiment of the disclosure, when traffic of the RU (e.g., the RU 507, the RU 509, or the RU 511) is temporarily low, the system operator 501 may input a low-power mode signal for setting a low-power mode to the control software 505 to set the RU (hereinafter, the RU 507, the RU 509, or the RU 511) to the low-power mode. For example, traffic of the RU may be temporarily low in the late night time zone. For example, traffic of an RU located in a residential area may be temporarily low in the morning time zone. For example, traffic of the RU located in a business area may be temporarily low during the evening time zone. The system operator 501 may input, into the control software 505, a low power mode signal to set the RU to a low power mode in a time zone when traffic of the RU is temporarily low.

According to an embodiment of the disclosure, the control software 505 may transmit, to the RU through at least one transceiver (e.g., the transceiver 310 of FIG. 3A), a configuration request message for the DU 503 to set a low power mode. The configuration request message may include period information for indicating a transmission period of an inspection request message and counter information for indicating a maximum number of transmissions of the inspection request message. For example, the configuration request message may include period information for indicating a transmission period of about 1 hour and counter information 5 times. The configuration request message may include RU identifier information for identifying the RU and information on a frequency band for setting the low power mode. For example, the configuration request message may include information on port identification (ID) of the RU and information on about 3.5 giga-hertz (GHZ) band. The port ID of the RU may be used to check whether the configuration request message is received by the RU for setting the low power mode. The information on the frequency band may be used to determine whether to deactivate at least one component of the RU with respect to which frequency band when one RU services a plurality of frequency bands. For example, the RU may service a plurality of frequency bands among frequency bands of about 800 Mega-Hertz (MHz), about 900 MHz, about 1.8 Giga-Hertz (GHz), about 1.9 GHz, about 2.6 GHz, and about 3.5 GHz. The information on the frequency band included in the configuration request message may indicate whether to set the low power mode with respect to which frequency bands among frequency bands served by the RU. Since a coverage decreases as the frequency increases, a component for a frequency of about 3.5 GHz may be deactivated in the late night time zone. The configuration request message may be transmitted from the DU 503 to the RU via a common public radio interface (CPRI), an e-CPRI interface, or an open-radio access network (O-RAN) interface.

According to an embodiment of the disclosure, the RU 509 may deactivate the at least one component of the RU 509 after receiving the configuration request message. For example, the at least one component may be a transceiver. For example, the at least one component may be another component except for a counter block or memory. For example, the RU 509 may deactivate other components except the counter block or memory for power saving. The counter block or the memory may be excluded from the at least one component that is deactivated to identify a check point (inspection time point) based on the period information. The memory may store the period information. For example, the memory may store period information reaching a check point approximately every 1 hour. The RU 509 in the low power mode may deactivate at least one component for saving power. In the low power mode, the RU 509 may not receive a message from the DU 503 before the check point is reached. It may be because a component transmitting or receiving a message with the DU 503 is deactivated for power saving. The memory may be flash memory. The memory may be included in the RU 509. The memory may be disposed outside a field programmable gate array (FPGA) chip. The FPGA chip may include the counter block.

According to an embodiment of the disclosure, the RU 509 may transmit, to the DU 503, an inspection request message for identifying a transition to a normal mode based on the period information. For example, the RU 509 may activate a component that has been deactivated about once every 1 hour and transmit the inspection request message to the DU 503. The RU 509 may transmit the inspection request message, based on the period information, via the counter block and the memory. The counter block may identify whether a check point determined according to the period information is reached. When the check point is reached, the counter block may activate at least one component required for transmitting an inspection request message and receiving an inspection response message. For example, at least one component required for transmitting an inspection request message and receiving an inspection response message may include a transceiver.

According to an embodiment of the disclosure, the DU 503 may receive the inspection request message for identifying a transition to a normal mode, from the RU 509. The RU 509 set to the low power mode may transmit the inspection request message to check whether to transition to the normal mode. According to an embodiment of the disclosure, the DU 503 may transmit, to the RU 509, an inspection response message indicating the low power mode or the normal mode, in response to the inspection request message. The RU 509 may deactivate other components constituting the RU 509 based on an inspection response message indicating the low power mode. For example, the other components to be deactivated may be components other than the counter block and the transceiver. The RU 509 has been described as receiving the inspection response message indicating the low power mode, but embodiments of the disclosure are not limited thereto. For example, in a case of the low power mode, the inspection response message may not be received from the DU 503 to the RU 509. When the inspection response message is not received, the RU 509 may be identified as indicating the low power mode. According to an embodiment of the disclosure, when the DU 503 obtains an input indicating the normal mode, the DU 503 may transmit the inspection response message indicating the normal mode to the RU 509. The DU 503 may obtain, via the control software 505 from the system operator 501, an input indicating the normal mode between a first check point and a second check point. The first check point may be a time point at which a first inspection request message identified based on the period information is transmitted after a time point set to the low power mode. The second check point may be a time point at which a second inspection request message identified based on the period information is transmitted after a time point set to the low power mode. For example, the first check point may be a point about 1 hour after the low power mode is set. The second check point may be a point about 2 hours after the low power mode is set. The DU 503 may transmit the inspection response message indicating the normal mode at the second inspection time. The inspection response message indicating the normal mode may correspond to the input indicating the normal mode.

According to an embodiment of the disclosure, the RU 509 may activate the at least one component of the RU 509, based on receiving the inspection response message for indicating the normal mode. When the inspection response message for indicating the normal mode is received, the RU 509 may activate the at least one component even if the number of transmissions of the inspection request message is not greater than the maximum number of transmissions. In the normal mode, the RU 509 may activate the at least one component deactivated to save power in the low power mode.

According to an embodiment of the disclosure, the RU 509 may reboot the RU 509 based on receiving the inspection response message for indicating the normal mode. The rebooting may be performed through a booter. The booter may be an operating system (OS) for rebooting.

According to an embodiment of the disclosure, when the number of transmissions of the inspection request message exceeds the maximum number of transmissions, the RU 509 may be transitioned to the normal mode. This is because the configuration request message for setting the low power mode includes a request to transition to the normal mode when the number of transmissions of the inspection request message exceeds the maximum number of transmissions. For example, the RU 509 may receive a configuration request message including period information indicating about 1 hour and counter information indicating 4 times. When the inspection request message transmitted about once every 1 hour is transmitted five times, the RU 509 may be transitioned to a normal mode. According to an embodiment of the disclosure, in a case that the number of transmissions of the inspection request message reaches the maximum number of transmissions, the RU 509 may activate the at least one component of the RU 509. According to an embodiment of the disclosure, in a case that the number of transmissions of the inspection request message exceeds the maximum number of transmissions, the RU 509 may reboot the RU 509.

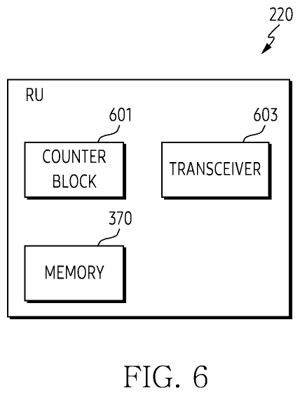

FIG. 6 illustrates a functional configuration of a radio unit (RU) activated in a low power mode according to an embodiment of the disclosure.

Referring to FIG. 6, the RU 220 may include a counter block 601, a transceiver 603, and memory 370.

According to an embodiment of the disclosure, the counter block 601 may identify whether a check point determined according to the period information is reached. When the check point is reached, the counter block 601 may activate at least one component required for transmitting an inspection request message and receiving an inspection response message by referring to the period information stored in the memory 370. For example, the at least one component required for transmitting the inspection request message and receiving the inspection response message may include a transceiver. The counter block may be an operating system (OS) in a field programmable gate array (FPGA) chip.

According to an embodiment of the disclosure, the memory 370 may store the period information. For example, the memory may store period information reaching a check point approximately every 1 hour. The memory 370 may be disposed outside a field programmable gate array (FPGA) chip.

According to an embodiment of the disclosure, the RU 220 may perform communication with a distributed unit (DU) (e.g., the DU 210 of FIG. 2) through the transceiver 603. The transceiver may include a transmit/receive unit.

According to an embodiment of the disclosure, after the RU 220 receives a configuration request message for setting a low power mode from the DU 210, the RU 220 may deactivate components including the transceiver 603 for power saving. For example, the components including the transceiver 603 may not include the counter block 601 or the memory 370. Components activated in the low power mode may be the counter block 601 and the memory 370. In the low power mode, some components of the RU 220 may be activated in order for the counter block 601 to transmit an inspection request message, based on the period information stored in the memory 370. The some components may include the transceiver 603. The activated transceiver 603 may transmit an inspection request message to the DU 210. The activated transceiver 603 may receive an inspection response message corresponding to the inspection request message from the DU 210. The inspection response message may indicate a low power mode or a normal mode. The RU 220 may deactivate other components constituting the RU 220 based on the inspection response message indicating the low power mode. For example, the other components to be deactivated may be components other than the counter block 601 and the transceiver 603. The RU 220 has been described as receiving the inspection response message indicating the low power mode, but embodiments of the disclosure are not limited thereto. For example, in a case of the low-power mode, the inspection response message may not be received from the DU 210 to the RU 220. When the inspection response message is not received, the RU 220 may be identified as indicating the low power mode. According to an embodiment of the disclosure, when the DU 210 obtains an input indicating the normal mode, the DU 210 may transmit the inspection response message indicating the normal mode to the RU 220. The input indicating the normal mode may be obtained from a system operator between a first check point and a second check point.

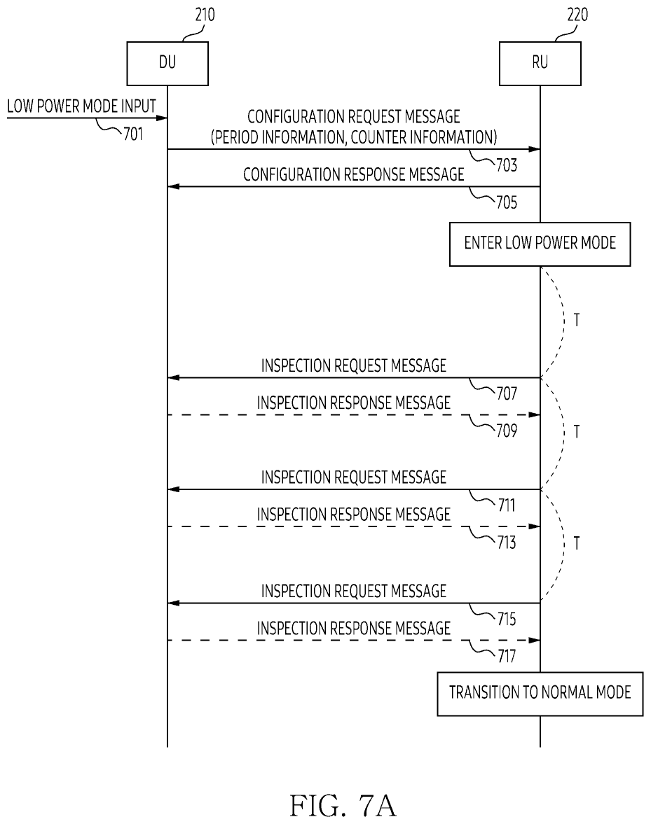

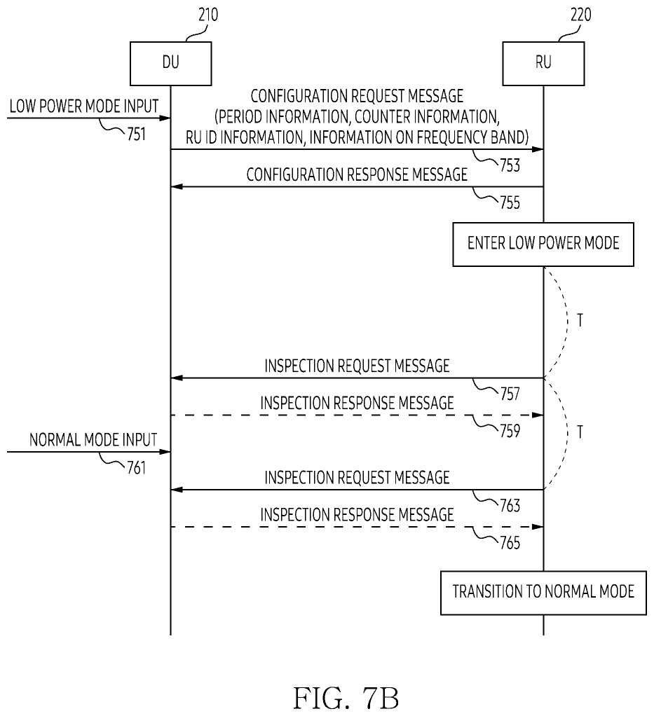

FIG. 7A illustrates signaling between a distributed unit (DU) and a radio unit (RU) for a transition to a normal mode based on counter information, according to an embodiment of the disclosure.

Referring to FIG. 7A, in operation 701, according to an embodiment of the disclosure, a DU (e.g., the DU 210 of FIG. 2) may receive a signal indicating a low power mode. According to an embodiment of the disclosure, when traffic of the RU (e.g., the RU 220 of FIG. 2) is temporarily low, a system operator may input, into the DU 210, a low-power mode signal for setting the low-power mode in order to set the RU 220 to the low-power mode. For example, traffic of the RU 220 may be temporarily low in the late night time zone. For example, traffic of the RU 220 located in a residential area in the morning time zone may be temporarily low. For example, traffic of the RU 220 located in a business area may be temporarily low during the evening time zone. The system operator may input, into the DU 210, a low power mode signal for setting the RU 220 to the low power mode in a time zone when traffic of the RU 220 is temporarily low.

In operation 703, according to an embodiment of the disclosure, the DU 210 may transmit a configuration request message to the RU 220. The configuration request message may include period information for indicating a transmission period of an inspection request message and counter information for indicating a maximum number of transmissions of the inspection request message. For example, the configuration request message may include period information for indicating a period of about 1 hour and counter information 2 times.

According to an embodiment of the disclosure, the configuration request message may further include RU 220 identifier information for identifying the RU 220. For example, the configuration request message may include a port identification (ID) of the RU 220. The DU 210 may include identifier information of the RU 220 in the configuration request message in order to explicitly indicate an RU for deactivation.

According to an embodiment of the disclosure, the configuration request message may further include information on a frequency band for setting a low power mode. For example, the configuration request message may include port identification (ID) of the RU 220 and information of about 3.5 giga-hertz (GHZ) band. The RU 220 may support a plurality of frequency bands. For example, the RU 220 may support a dual band. The port ID of the RU 220 may be used to determine whether the configuration request message has been received by the RU 220 for which the low power mode is to be set. The information on the frequency band may be used to determine whether to deactivate at least one component of the RU with respect to which frequency band when one RU 220 services a plurality of frequency bands For example, the RU 220 may service a plurality of frequency bands among frequency bands of about 800 Mega-Hertz (MHz), about 900 MHz, about 1.8 Giga-Hertz (GHz), about 1.9 GHz, about 2.6 GHz, and about 3.5 GHz. The information on the frequency band included in the configuration request message may indicate whether to set the low power mode with respect to which frequency bands among frequency bands served by the RU. Since a coverage decreases as the frequency increases, a component for a frequency of about 3.5 GHz may be deactivated in the late night time zone. The configuration request message may be transmitted from the DU 503 to the RU 220 via a common public radio interface (CPRI), an e-CPRI interface, or an open-radio access network (O-RAN) interface.

In operation 705, according to an embodiment of the disclosure, the RU 220 may transmit a configuration response message to the DU 210. Through the configuration response message, the DU 210 may identify whether the low power mode is set as the configuration request message is transmitted to the RU 220. According to an embodiment of the disclosure, the RU 220 may enter the low power mode after receiving the configuration request message. The RU 220 may deactivate the at least one component of the RU 220 for power saving, in the low power mode. For example, the at least one component may be a transceiver. For example, the at least one component may be another component other than a counter block or memory. For example, the RU 220 may deactivate other components except for the counter block or the memory for power saving. The counter block or the memory may be excluded from the at least one component that is deactivated to identify a check point based on the period information. The memory may store the period information. For example, the memory may store period information reaching a check point approximately every 1 hour. The RU 220 in the low power mode may deactivate at least one component for saving power. In the low power mode, the RU 220 may not receive a message from the DU 210 before the check point is reached. It may be because a component transmitting or receiving a message with the DU 210 is deactivated for power saving. The memory may be flash memory. The memory may be included in the RU 220. The memory may be disposed outside a field programmable gate array (FPGA) chip. The FPGA chip may include the counter block.

In operation 707, according to an embodiment of the disclosure, the RU 220 may transmit an inspection request message to the DU 210. According to an embodiment of the disclosure, the RU 220 may transmit, to the DU 210, an inspection request message for identifying a transition to a normal mode based on the period information. For example, the RU 220 may activate a component that has been deactivated about every 1 hour and transmit the inspection request message to the DU 210. The RU 220 may transmit the inspection request message, based on the period information, via the counter block and the memory. The counter block may identify whether a check point determined according to the period information is reached. When the check point is reached, the counter block may activate at least one component required for transmitting an inspection request message and receiving an inspection response message.

In operation 709, according to an embodiment of the disclosure, the DU 210 may transmit the inspection response message to the RU 220. According to an embodiment of the disclosure, the DU 210 may transmit an inspection response message indicating the low power mode to the RU 220, in response to the inspection request message. The RU 220 may deactivate other components constituting the RU 220, based on the inspection response message indicating the low power mode. For example, other components to be deactivated may be components other than a counter block and a transceiver. Although the RU 220 has been described as receiving the inspection response message indicating the low power mode, embodiments of the disclosure are not limited thereto. For example, in a case of the low power mode, the inspection response message may not be received from the DU 210 to the RU 220. When the inspection response message is not received, the RU 220 may be identified as indicating the low power mode.

In operation 711, according to an embodiment of the disclosure, the RU 220 may transmit the inspection request message to the DU 210. The RU 220 may identify an inspection time based on the period time. The inspection time may be a time point at which the period time is reached for a second time after entering the low power mode. The operation 707 may be referred to the second transmitted inspection request message.

In operation 713, according to an embodiment of the disclosure, the DU 210 may transmit the inspection response message to the RU 220. The DU 210 may transmit an inspection response message corresponding to the second transmitted inspection request message to the RU 220. The operation 709 may be referred to the second transmitted inspection response message.

In operation 715, according to an embodiment of the disclosure, the RU 220 may transmit the inspection request message to the DU 210. The RU 220 may identify an inspection time based on the period time. The inspection time may be a time point at which the period time is reached for a third time after entering the low power mode. The operation 707 may be referred to the second transmitted inspection request message.

In operation 717, according to an embodiment of the disclosure, the DU 210 may transmit the inspection response message to the RU 220. The DU 210 may transmit the inspection response message to the RU 220. The DU 210 may transmit an inspection response message corresponding to the third transmitted inspection request message to the RU 220. The operation 709 may be referred to the third transmitted inspection response message.

According to an embodiment of the disclosure, the RU 220 may be transitioned to a normal mode, in a case that the number of transmissions of the inspection request message exceeds the maximum number of transmissions. This is because the configuration request message for setting the low power mode includes a request to transition to the normal mode when the number of transmissions of the inspection request message exceeds the maximum number of transmissions. For example, after receiving a configuration request message in which the period information is about 1 hour and the counter information is twice, the RU 220 may be transitioned to the normal mode, in a case that the inspection request message transmitted about once every hour is transmitted three times. According to an embodiment of the disclosure, the RU 220 may activate the at least one component of the RU 220 when the number of transmissions of the inspection request message is greater than the maximum number of transmissions. According to an embodiment of the disclosure, the RU 220 may reboot the RU 220 when the number of transmissions of the inspection request message is greater than the maximum number of transmissions. The reboot may be performed via a booter. The booter may be an operating system (OS) for rebooting.

FIG. 7B illustrates signaling between a distributed unit (DU) and a radio unit (RU) for a transition to a normal mode based on an inspection response message, according to an embodiment of the disclosure.

Referring to FIG. 7B, in operation 751, according to an embodiment of the disclosure, a DU (e.g., the DU 210 of FIG. 2) may receive a signal indicating a low power mode. According to an embodiment of the disclosure, when traffic of the RU (e.g., the RU 220 of FIG. 2) is temporarily low, a system operator may input, into the DU 210, a low-power mode signal for setting a low-power mode to set the RU 220 to the low-power mode. The operation 701 of FIG. 7A may be referred to for the contents of the configuration request message.

In operation 753, according to an embodiment of the disclosure, the DU 210 may transmit a configuration request message to the RU 220. The configuration request message may include period information for indicating a transmission period of an inspection request message and counter information for indicating a maximum number of transmissions of the inspection request message. The operation 703 of FIG. 7A may be referred to for the contents of the configuration request message.

In operation 755, according to an embodiment of the disclosure, the RU 220 may transmit a configuration response message to the DU 210. Through the configuration response message, the DU 210 may identify whether the low power mode is set as the configuration request message is transmitted to the RU 220. According to an embodiment of the disclosure, the RU 220 may enter a low power mode after receiving the configuration request message. The RU 220 may deactivate the at least one component of the RU 220 for power saving, in the low power mode. The operation 705 of FIG. 7A may be referred to for the contents of the configuration response message and the low power mode.

In operation 757, according to an embodiment of the disclosure, the RU 220 may transmit an inspection request message to the DU 210. According to an embodiment of the disclosure, the RU 220 may transmit, to the DU 210, an inspection request message for identifying a transition to a normal mode based on the period information. The operation 707 of FIG. 7A may be referred to for the contents of the inspection request message.

In operation 759, according to an embodiment of the disclosure, the DU 210 may transmit an inspection response message to the RU 220. According to an embodiment of the disclosure, the DU 210 may transmit, to the RU 220, an inspection response message indicating the low power mode, in response to the inspection request message. The operation 709 of FIG. 7A may be referred to for the contents of the inspection response message.

In operation 761, according to an embodiment of the disclosure, the DU 210 may receive a signal indicating the normal mode. According to an embodiment of the disclosure, when the DU 210 obtains an input indicating the normal mode, the DU 210 may transmit the inspection response message indicating the normal mode to the RU 220. The DU 210 may obtain an input indicating the normal mode from a system operator between a first check point and a second check point. The first check point may be a time point at which a second inspection request message identified based on the period information is transmitted after a time point set to the low power mode. The second check point may be a time point at which a third inspection request message identified based on the period information is transmitted after a time point set to the low power mode. For example, the first check point may be a point about 2 hours after the low power mode is set. The second check point may be a point about 3 hours after the low power mode is set.

In operation 763, the DU 210 may transmit a configuration request message to the RU 220. According to an embodiment of the disclosure, the RU 220 may transmit, to the DU 210, an inspection request message for identifying a transition to the normal mode based on the period information. The operation 707 of FIG. 7A may be referred to for the contents of the inspection request message.

In operation 765, the RU 220 may transmit a configuration response message to the DU 210. The DU 210 may transmit the inspection response message indicating the normal mode based on the normal mode input received between the first check point and the second check point. The inspection response message indicating the normal mode may correspond to an input indicating the normal mode.

According to an embodiment of the disclosure, the RU 509 may activate the at least one component of the RU 509 based on receiving the inspection response message for indicating the normal mode. When the inspection response message for indicating the normal mode is received, the RU 509 may activate the at least one component even if the number of transmissions of the inspection request message is not greater than the maximum number of transmissions. The RU 509 may activate the at least one component deactivated to reduce power in the low power mode, in the normal mode.

According to an embodiment of the disclosure, the RU 509 may reboot the RU 509 based on receiving the inspection response message for indicating the normal mode. The reboot may be performed through a booter that is an operating system (OS).

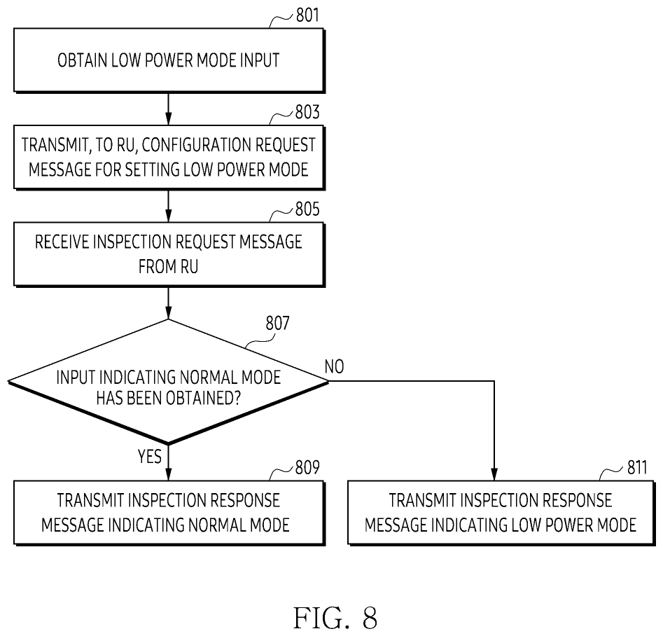

FIG. 8 illustrates a flow of operations of a distributed unit (DU) for power saving of a base station according to an embodiment of the disclosure.

Referring to FIG. 8, in operation 801, at least one processor (e.g., the processor 330 of FIG. 3A) of a DU (e.g., the DU 210 of FIG. 2) may obtain a low power mode input. According to an embodiment of the disclosure, when the traffic of the RU 220 is temporarily low, the system operator may input a low-power mode signal for setting the low-power mode to the DU 210 to set the RU 220 to a low-power mode. According to an embodiment of the disclosure, when traffic of the RU 220 is temporarily low, a system operator may input, into the DU 210, a low-power mode signal for setting a low-power mode to set the RU 220 to the low-power mode. For example, traffic of the RU 220 may be temporarily low in the late night time zone. For example, traffic of the RU 220 located in a residential area in the morning time zone may be temporarily low. For example, traffic of the RU 220 located in a business area may be temporarily low in the evening time zone. The system operator may input a low-power mode signal for setting the RU 220 to a low-power mode in a time when traffic of the RU 220 is temporarily low.

In operation 803, the at least one processor 330 of the DU 210 may transmit, to the RU 220, a configuration request message for setting a low power mode. The configuration request message may include period information for indicating a transmission period of an inspection request message, counter information for indicating a maximum number of transmissions of the inspection request message, RU identifier information for identifying the RU, and information on a frequency band for setting a low power mode. For example, the configuration request message may include period information for indicating a transmission period of about 1 hour and counter information of 4 times. For example, the configuration request message may include a port identification (ID) of the RU and information of about 3.5 giga-hertz (GHZ) band. The port ID of the RU may be used to check whether the configuration request message has been received by the RU for setting the low power mode. The information on the frequency band may be used to determine whether to deactivate at least one component of the RU with respect to which frequency band when one RU services a plurality of frequency bands. For example, the RU may service multiple frequency bands among the frequency bands of about 800 Mega-Hertz (MHz), about 900 MHz, about 1.8 Giga-Hertz (GHz), about 1.9 GHz, about 2.6 GHz, and about 3.5 GHz. The information on the frequency band included in the configuration request message may indicate whether to set a low power mode with respect to which frequency bands among frequency bands served by the RU. Since a coverage decreases as the frequency increases, a component for a frequency of about 3.5 GHz may be deactivated in the late night time zone. The configuration request message may be transmitted from the DU 503 to the RU via a common public radio interface (CPRI), an e-CPRI interface, or an open-radio access network (O-RAN) interface.

In operation 805, the at least one processor 330 may receive an inspection request message from the RU 220. The RU 220 set to the low power mode may transmit the inspection request message based on period information to check whether to transition to a normal mode. For example, the RU 220 may activate a component that has been deactivated about once every hour and transmit the inspection request message to the DU 210.

In operation 807, the at least one processor 330 of the DU 210 may identify whether an input indicating the normal mode has been obtained. When the input indicating the normal mode is obtained, the at least one processor 330 of the DU 210 may perform operation 809. When the input indicating the normal mode is not obtained, the at least one processor 330 of the DU 210 may perform operation 811. Even if the number of transmissions of the inspection request message of the RU 220 is not greater than the maximum number of transmissions, a system operator may activate the RU 220 through the input indicating the normal mode. The DU 210 may obtain the input indicating the normal mode from the system operator between a first check point and a second check point. The first check point may be a time point at which a first inspection request message identified based on the period information is transmitted after a time point set to the low power mode. The second check point may be a time point at which a second inspection request message identified based on the period information is transmitted after a time point set to the low power mode.

In operation 809, the at least one processor 330 of the DU 210 may transmit an inspection response message indicating the normal mode. The normal mode may be a state in which a base station normally serves a cell. The inspection response message indicating the normal mode may cause the RU 509 to activate the at least one component even if the number of transmissions of the inspection request message is not greater than the maximum number of transmissions.

In operation 811, the at least one processor 330 of the DU 210 may transmit an inspection response message indicating a low power mode. According to an embodiment of the disclosure, the inspection response message indicating the low power mode may be transmitted to the RU 220 in response to the inspection request message. Although the DU 210 has been described to transmit the inspection response message indicating the low power mode, embodiments of the disclosure are not limited thereto. For example, in a case of the low power mode, the inspection response message may not be received from the DU 210 to the RU 220.

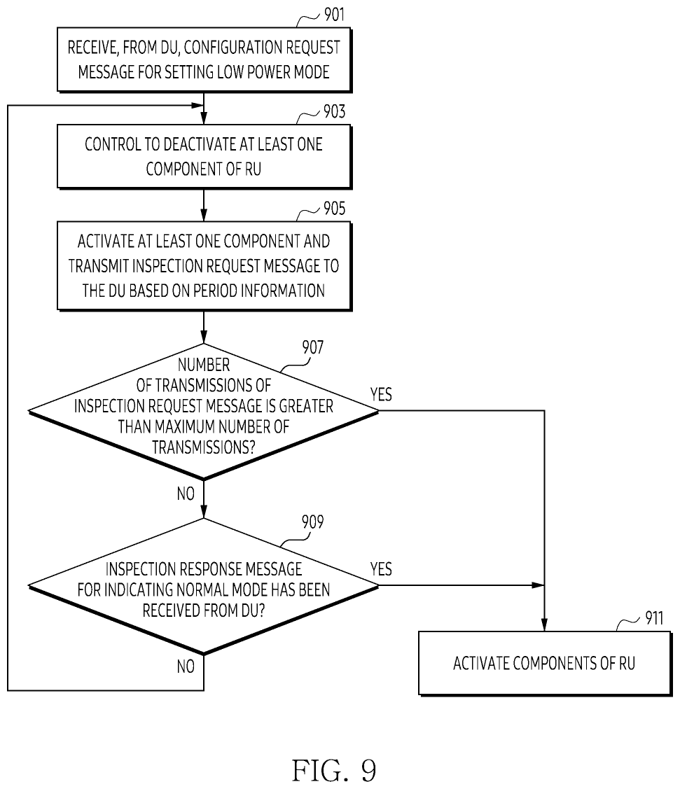

FIG. 9 illustrates a flow of operations of a radio unit (RU) for power saving of a base station according to embodiments.

Referring to FIG. 9, in operation 901, at least one processor (e.g., the processor 380 of FIG. 3B) of an RU (e.g., the RU 220 of FIG. 2) may receive, from a DU (e.g., the DU 210 of FIG. 2), a configuration request message for setting a low power mode. The operation 803 of FIG. 8 may be referred to for the contents of the configuration request message.

In operation 903, the at least one processor 380 of the RU 220 may control to deactivate at least one component of the RU 220. According to this configuration, the RU 220 may deactivate the at least one component of the RU 220 after receiving the configuration request message. For example, the at least one component may be a transceiver. For example, the at least one component may be another component other than a counter block or memory. For example, the RU 220 may deactivate other components other than the counter block or the memory for power saving. The counter block or the memory may be excluded from the at least one component that is deactivated to identify a check point, based on the period information. The memory may store the period information. The RU 220 in the low power mode may deactivate at least one component to reduce power. In the low power mode, the RU 220 may not receive a message from the DU 210 before the checkpoint is reached. It may be because a component transmitting or receiving a message with the DU 210 is deactivated for power saving. The memory may be flash memory. The memory may be included in the RU 220. The memory may be disposed outside a field programmable gate array (FPGA) chip. The FPGA chip may include the counter block.

In operation 905, the at least one processor 380 of the RU 220 may activate at least one component and transmit an inspection request message to the DU based on period information. For example, the RU 509 may activate a component that has been deactivated about once every hour and transmit the inspection request message to the DU 503. The RU 509 may transmit the inspection request message based on the period information, via the counter block and the memory. The counter block may identify whether a check point determined according to the period information is reached. When the check point is reached, the counter block may activate at least one component required for transmitting an inspection request message and receiving an inspection response message. For example, at least one component required for transmitting an inspection request message and receiving an inspection response message may include a transceiver.

In operation 907, the at least one processor 380 of the RU 220 may identify whether the number of transmissions of the inspection request message is greater than the maximum number of transmissions. When the number of transmissions of the inspection request message is greater than the maximum number of transmissions, the at least one processor 380 of the RU 220 may perform operation 911. When the number of transmissions of the inspection request message is not greater than the maximum number of transmissions, the at least one processor 380 of the RU 220 may perform operation 909. This is because the configuration request message for setting the low power mode includes a request to transition to a normal mode when the number of transmissions of the inspection request message is greater than the maximum number of transmissions.

In operation 909, the at least one processor 380 of the RU 220 may identify whether an inspection response message for indicating the normal mode has been received from the DU 210. When the inspection response message for indicating the normal mode is received from the DU 210, the at least one processor 380 of the RU 220 may perform operation 911. When the inspection response message for indicating the normal mode is received from the DU 210, the at least one processor 380 of the RU 220 may perform operation 903. When the inspection response message for indicating the low power mode is received, the RU 220 may set the low power mode. For example, the RU 220 may deactivate a component of the RU 220 for power saving.

In operation 911, the at least one processor 380 may activate components of the RU 220. When the inspection response message for indicating the normal mode is received, the RU 220 may set the normal mode. For example, the RU 220 may activate a component of the RU 220 to normally service the cell.

The effects that can be obtained from the disclosure are not limited to those described above, and any other effects not mentioned herein will be clearly understood by those having ordinary knowledge in the art to which the disclosure belongs, from the following description.

As described above, according to an embodiment of the disclosure, an electronic device of a radio unit (RU) 220, 507, 509, or 511 may comprise at least one transceiver 360, 365, or 603, and at least one processor 380 coupled with the at least one transceiver 360, 365, or 603. The at least one processor 380 may be configured to receive, via the at least one transceiver 360, 365, or 603, from a distributed unit (DU) 210, 251, or 503, a configuration request message for setting a low-power mode for deactivating at least one component of the RU 220, 507, 509, or 511. The configuration request message may include period information indicating a transmission period of an inspection request message and counter information indicating a maximum number of transmissions of the inspection request message. The at least one processor 380 may be configured to, after receiving the configuration request message, control the at least one component of the RU 220, 507, 509, or 511 to be deactivated. The at least one processor 380 may be configured to transmit the inspection request message for identifying a transition to a normal mode to the DU 210, 251, or 503 based on the period information. The at least one processor 380 may be configured to activate the at least one component of the RU 220, 507, 509, or 511 based on the number of transmissions of the inspection request message being exceeding the maximum number of transmissions or an inspection response message indicating the normal mode being received.

According to an embodiment of the disclosure, the configuration request message may further include RU identifier information for identifying the RU 220, 507, 509, or 511.

According to an embodiment of the disclosure, the configuration request message may include information on a frequency band for setting the low-power mode. After receiving the configuration request message, the at least one component may be deactivated with respect to the information on the frequency band in order to deactivate the at least one component. The at least one component may be activated with respect to the information on the frequency band in order to activate the at least one component of the RU 220, 507, 509, or 511.

According to an embodiment of the disclosure, the at least one component may not include a counter block 601 and memory 370 for activating the at least one component based on the period information. The memory 370 may store the period information. The counter block 601 may identify whether a check point determined according to the period information is reached.

According to an embodiment of the disclosure, in order to transmit the inspection request message, the at least one processor 380 may be configured to store the period information through the memory 370. In order to transmit the inspection request message, the at least one processor 380 may be configured to identify whether the check point determined based on the period information is reached through the counter block 601. In order to transmit the inspection request message, the at least one processor 380 may be configured to, in a case that the check point is reached, activate the at least one component for transmitting the inspection request message.

As described above, according to an embodiment of the disclosure, an electronic device of a distributed unit (DU) 210, 251, or 503 may comprise at least one transceiver 310, and at least one processor 330 coupled with the at least one transceiver 310. The at least one processor 330 may be configured to transmit, to a radio unit (RU) 220, 507, 509, or 511, a configuration request message for setting a low-power mode for deactivating at least one component of the RU 220, 507, 509, or 511. The configuration request message may include period information indicating a transmission period of an inspection request message and counter information indicating a maximum number of transmissions of the inspection request message. The at least one processor 330 may be configured to receive the inspection request message for identifying a transition to a normal mode from the RU 220, 507, 509, or 511. The at least one processor 330 may be configured to transmit an inspection response message indicating the low-power mode or the normal mode to the RU 220, 507, 509, or 511 in response to the inspection request message.

According to an embodiment of the disclosure, the configuration request message may further include RU identifier information for identifying the RU 220, 507, 509, or 511.

According to an embodiment of the disclosure, the configuration request message may include information on a frequency band for setting the low-power mode. The information on the frequency band may be referred to in order to activate or deactivate the at least one component of the RU 220, 507, 509, or 511.

According to an embodiment of the disclosure, the at least one component may not include a counter block 601 and memory 370 for activating the at least one component based on the period information. The memory 370 may store the period information. The counter block 601 may identify whether a check point determined according to the period information is reached.

According to an embodiment of the disclosure, the at least one processor 330 may be configured to further obtain an input indicating the normal mode. The inspection response message indicating the normal mode may be transmitted to the RU 220, 507, 509, or 511 based on the obtaining the input indicating the normal mode.

As described above, according to an embodiment of the disclosure, a method performed by a radio unit (RU) 220, 507, 509, or 511 may comprise receiving, via at least one transceiver 360, 365, or 603, from a distributed unit (DU) 210, 251, or 503, a configuration request message for setting a low-power mode for deactivating at least one component of the RU 220, 507, 509, or 511. The configuration request message may include period information indicating a transmission period of an inspection request message and counter information indicating a maximum number of transmissions of the inspection request message. The method may comprise controlling the at least one component of the RU 220, 507, 509, or 511 to be deactivated, after receiving the configuration request message. The method may comprise transmitting the inspection request message for identifying a transition to a normal mode to the DU 210, 251, or 503 based on the period information. The method may comprise activating the at least one component of the RU 220, 507, 509, or 511 based on the number of transmissions of the inspection request message being exceeding the maximum number of transmissions or an inspection response message indicating the normal mode being received.

According to an embodiment of the disclosure, the configuration request message may further include RU identifier information for identifying the RU 220, 507, 509, or 511.

According to an embodiment of the disclosure, the configuration request message may include information on a frequency band for setting the low-power mode. After receiving the configuration request message, the at least one component may be deactivated with respect to the information on the frequency band in order to deactivate the at least one component. The at least one component may be activated with respect to the information on the frequency band, in order to activate the at least one component of the RU 220, 507, 509, or 511.

According to an embodiment of the disclosure, the at least one component may not include a counter block 601 and memory 370 for activating the at least one component based on the period information. The memory 370 may store the period information. The counter block 601 may identify whether a check point determined according to the period information is reached.

According to an embodiment of the disclosure, the transmitting the inspection request message comprises storing the period information through the memory 370. The transmitting the inspection request message comprises identifying whether the check point determined based on the period information is reached through the counter block 601. The transmitting the inspection request message comprises, in a case that the check point is reached, activating the at least one component for transmitting the inspection request message.

As described above, according to an embodiment of the disclosure, a method performed by a distributed unit (DU) 210, 251, or 503 may comprise transmitting, to a radio unit (RU) 220, 507, 509, or 511, a configuration request message for setting a low-power mode for deactivating at least one component of the RU 220, 507, 509, or 511. The configuration request message may include period information indicating a transmission period of an inspection request message and counter information indicating a maximum number of transmissions of the inspection request message. The method may comprise receiving the inspection request message for identifying a transition to a normal mode from the RU 220, 507, 509, or 511. The method may comprise transmitting, in response to the inspection request message, an inspection response message indicating the low-power mode or the normal mode to the RU 220, 507, 509, or 511.

According to an embodiment of the disclosure, the configuration request message may further include RU identifier information for identifying the RU 220, 507, 509, or 511.

According to an embodiment of the disclosure, the configuration request message may include information on a frequency band for setting the low-power mode. The information on the frequency band may be referred to in order to activate or deactivate the at least one component of the RU 220, 507, 509, or 511.

According to an embodiment of the disclosure, the at least one component may not include a counter block 601 and memory 370 for activating the at least one component based on the period information. The memory 370 may store the period information. The counter block 601 may identify whether a check point determined according to the period information is reached.

According to an embodiment of the disclosure, the method may further comprise obtaining an input indicating the normal mode. The inspection response message indicating the normal mode may be transmitted to the RU 220, 507, 509, or 511 based on the obtaining the input indicating the normal mode.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 330) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

Methods according to embodiments described in claims or specifications of the disclosure may be implemented as a form of hardware, software, or a combination of hardware and software. In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Additionally, a program may be stored in an attachable storage device that may be accessed through a communication network, such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device of a radio unit (RU), the electronic device comprising:
memory, comprising one or more storage media, storing instructions;
at least one transceiver; and
at least one processor communicatively coupled to the at least one transceiver and the memory,
wherein the instructions, when executed by the at least one processor individually or collectively, cause the RU to:
receive, via the at least one transceiver from a distributed unit (DU), a configuration request message for setting a low-power mode for deactivating at least one component of the RU, the configuration request message including period information indicating a transmission period of an inspection request message and counter information indicating a maximum number of transmissions of the inspection request message,
after receiving the configuration request message, control the at least one component of the RU to be deactivated,
transmit the inspection request message for identifying a transition to a normal mode to the DU based on the period information, and
activate the at least one component of the RU based on the number of transmissions of the inspection request message being exceeding the maximum number of transmissions or an inspection response message indicating the normal mode being received.

2. The electronic device of claim 1, wherein the configuration request message further includes RU identifier information for identifying the RU.

3. The electronic device of claim 1,
wherein the configuration request message includes information on a frequency band for setting the low-power mode,
wherein, after receiving the configuration request message, the at least one component is deactivated with respect to the information on the frequency band in order to deactivate the at least one component, and
wherein the at least one component is activated with respect to the information on the frequency band in order to activate the at least one component of the RU.

4. The electronic device of claim 1,
wherein the at least one component does not include a counter block and memory for activating the at least one component based on the period information,
wherein the memory stores the period information, and
wherein the counter block identifies whether a check point determined according to the period information is reached.

5. The electronic device of claim 4, wherein the instructions, when executed by the at least one processor individually or collectively in order to transmit the inspection request message, further cause the RU to:
store the period information through the memory,
identify whether the check point determined based on the period information is reached through the counter block, and
in a case that the check point is reached, activate the at least one component for transmitting the inspection request message.

6. An electronic device of a distributed unit (DU), the electronic device comprising:
memory, comprising one or more storage media, storing instructions;
at least one transceiver; and
at least one processor communicatively coupled to the at least one transceiver and the memory,
wherein the instructions, when executed by the at least one processor individually or collectively, cause the DU to:
transmit, to a radio unit (RU), a configuration request message for setting a low-power mode for deactivating at least one component of the RU, wherein the configuration request message includes period information indicating a transmission period of an inspection request message and counter information indicating a maximum number of transmissions of the inspection request message,
receive the inspection request message for identifying a transition to a normal mode from the RU, and
transmit an inspection response message indicating the low-power mode or the normal mode to the RU in response to the inspection request message.

7. The electronic device of claim 6 wherein the configuration request message further includes RU identifier information for identifying the RU.

8. The electronic device of claim 6,
wherein the configuration request message includes information on a frequency band for setting the low-power mode, and
wherein the information on the frequency band is referred to in order to activate or deactivate the at least one component of the RU.

9. The electronic device of claim 6,
wherein the at least one component does not include a counter block and memory for activating the at least one component based on the period information,
wherein the memory stores the period information, and
wherein the counter block identifies whether a check point determined according to the period information is reached.

10. The electronic device of claim 9,
wherein the instructions, when executed by the at least one processor individually or collectively, further cause the DU to obtain an input indicating the normal mode, and
wherein the inspection response message indicating the normal mode is transmitted to the RU based on the obtaining the input indicating the normal mode.

11. A method performed by a radio unit (RU), the method comprising:
receiving, via at least one transceiver from a distributed unit (DU), a configuration request message for setting a low-power mode for deactivating at least one component of the RU, wherein the configuration request message includes period information indicating a transmission period of an inspection request message and counter information indicating a maximum number of transmissions of the inspection request message;
controlling the at least one component of the RU to be deactivated, after receiving the configuration request message;
transmitting the inspection request message for identifying a transition to a normal mode to the DU based on the period information; and
activating the at least one component of the RU based on the number of transmissions of the inspection request message being exceeding the maximum number of transmissions or an inspection response message indicating the normal mode being received.

12. The method of claim 11, wherein the configuration request message further includes RU identifier information for identifying the RU.

13. The method of claim 11,
wherein the configuration request message includes information on a frequency band for setting the low-power mode,
wherein, after receiving the configuration request message, the at least one component is deactivated with respect to the information on the frequency band in order to deactivate the at least one component, and
wherein the at least one component is activated with respect to the information on the frequency band in order to activate the at least one component of the RU.

14. The method of claim 11,
wherein the at least one component does not include a counter block and memory for activating the at least one component based on the period information,
wherein the memory stores the period information, and
wherein the counter block identifies whether a check point determined according to the period information is reached.

15. The method of claim 11, wherein the transmitting the inspection request message comprises:
storing the period information through the memory,
identifying whether the check point determined based on the period information is reached through the counter block, and
in a case that the check point is reached, activating the at least one component for transmitting the inspection request message.

16. A method performed by a distributed unit (DU), the method comprising:
transmitting, to a radio unit (RU), a configuration request message for setting a low-power mode for deactivating at least one component of the RU, wherein the configuration request message includes period information indicating a transmission period of an inspection request message and counter information indicating a maximum number of transmissions of the inspection request message;
receiving the inspection request message for identifying a transition to a normal mode from the RU; and
transmitting, in response to the inspection request message, an inspection response message indicating the low-power mode or the normal mode to the RU.

17. The method of claim 16, wherein the configuration request message further includes RU identifier information for identifying the RU.

18. The method of claim 16,
wherein the configuration request message includes information on a frequency band for setting the low-power mode, and
wherein the information on the frequency band is referred to in order to activate or deactivate the at least one component of the RU.

19. The method of claim 16,
wherein the at least one component does not include a counter block and memory for activating the at least one component based on the period information,
wherein the memory stores the period information, and
wherein the counter block identifies whether a check point determined according to the period information is reached.

20. The method of claim 19, further comprising:
obtain an input indicating the normal mode, and
wherein the inspection response message indicating the normal mode is transmitted to the RU based on the input indicating the normal mode.
